(19) United States
(12) Patent Application Publication
(10) Pub. No.: US 2024/0248893 A1
(43) Pub. Date: Jul. 25, 2024

(54) SYSTEM AND METHOD FOR MAINTAINING STABLE IDENTIFIERS FOR DATA RECORDS

(71) Applicant: Perpetual Block AG, Zug (CH)

(72) Inventors: Nitish Jain, Jaipur (IN); Rahul Malu, Kota (IN); Rohit Anurag, Bokaro (IN); Sneha Yadav, Pune (IN)

(73) Assignee: Perpetual Block AG, Zug (CH)

(21) Appl. No.: 18/101,558

(22) Filed: Jan. 25, 2023

(51) Int. Cl. G06F 16/23

(52) U.S. Cl. CPC G06F 16/2379

(57) ABSTRACT

Disclosed herein is a system and method for assigning a unique identifier for an asset. The method disclosed herein relates to assigning a stable unique identifier for a final data record corresponding to an asset wherein the unique identifier encompasses changes in underlying data that make up the final data record. The method ensures that the unique identifier is not frequently updated based on changes in underlying data. The method further comprises mapping, based on a voting algorithm, a current final identifier to a new sourcework record received on account of changes to source data. The new identifier is updated in a mapping repository along with the previous final identifier and history of changes.

### TECHNICAL FIELD

This disclosure relates to generally to computer systems and processes for information storages, and, more particularly, to generating and maintaining unique identifiers for assets.

### BACKGROUND

NFTs, paintings, artworks etc. have been quite popular amongst urban crowd. People tend to stock these collections with them for the purpose of enjoyment, reputation and as a collection masterpiece. These assets are auctioned throughout the world in various auction houses. The auction house maintains the information pertaining to these assets. Given the internet age, said information is also maintained in digital files for easy accessibility by the public. Each asset is assigned an identifier that is used to retrieve details pursuant to the asset. However, in several cases, information pertaining to same asset ends up in catalogues as distinct entries leading to duplication. This generally occurs to disparity in standards of recording information across auction houses and aggregator platforms. Further, this information keeps updating as and when new sources are accessed or when the data on the existing sources updates. The updates from the data sources results in new identifier being generated since the identifier is generally based on existing data sources.

Conventionally, digital files relating to auction details of an asset are assigned a static id that does not change on any update to the underlying data. Further, in some cases asset identifiers are updated manually and any changes in source data is reflected in the new identifier. Moreover, in yet another scenario, new identifiers as well as old identifiers are maintained corresponding to an asset.

Manual intervention-based identifier generation requires extensive amount of time, labor and cost. Moreover, said manual exercises are always prone to human error of judgment as well as passthrough errors. Furthermore, the static identifiers result in identifiers not reflecting changes in underlying data. Preserving old and new identifiers for every updation in underlying data results in memory wastage.

In light of above mentioned problems, there does not exist a solution that provides a automated and accurate method for generating a stable identifier for an asset wherein the details pertaining to the asset are dynamically changing. Therefore, it is desirable to have a system and process that allows generation and maintenance of an identifier pertaining to an asset that

### SUMMARY

The present disclosure seeks to provide a system and a computer implemented method for assigning a unique identifier for an asset. The method disclosed herein relates to assigning a stable unique identifier for a final data record corresponding to an asset wherein the unique identifier encompasses changes in merging logic of one or more sourcework records that make up the final data record. The method further comprises mapping, based on a voting algorithm, a current final identifier to a new sourcework record received on account of changes to source data. The new identifier is updated in a mapping repository along with the previous final identifier and history of changes.

Embodiments of the present disclosure substantially eliminate or at least partially address the aforementioned problems.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments are better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 depicts the block diagram of the exemplary system as per the present disclosure.

FIG. 2 is a flow chart depicting the method steps of the present invention.

It will be appreciated that the drawings illustrated herein are for representation purposes only and do not intend to limit the scope of the present disclosure, and actual implementation of the present disclosure may be viewed substantially differently.

### DETAILED DESCRIPTION

The following description illustrates embodiments of the present disclosure and ways in which they can be implemented. Although some modes of carrying out the present disclosure have been disclosed, those skilled in the art would recognize that other embodiments for carrying out or practicing the present disclosure are also possible.

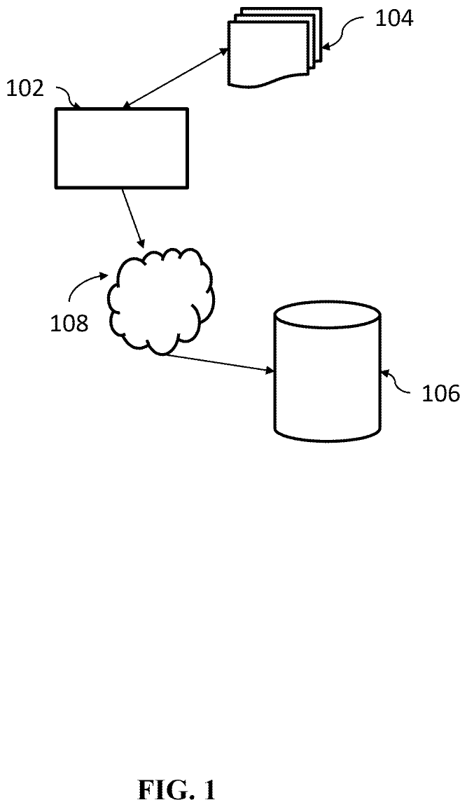

Referring to FIG. 1, the system comprises a processor 102 with a memory 104 comprising executable non-transitory machine-readable instructions wherein the processor 102 is configured to execute the said machine-readable instructions, and wherein the processor 102 is communicably coupled to a mapping repository 106 via a data communication network 108. The processor 102 is configured to determine a change in one or more sourcework records, retrieved from data sources, for a final data record pertaining to an asset and based on that determination assign a new unique identifier encompassing a new sourcework record wherein the new unique identifier is assigned based on a voting algorithm,

Throughout this disclosure, the term “data sources” means websites of auction houses and aggregator platforms that hosts auction houses data. These data sources contain information of all auctions that have taken place related to one or more assets within their rules and procedures. The term “sourcework records” means information pertaining to auction details of an asset such as lot number, sale price, event date, creation date, location etc. Further, the term “asset” refers to an item which is subject to auction in auction houses. Said items can be vintage cars, paintings, NFTs or sculpture works.

In an aspect of the present invention, the processor 102 is operable to determine a change in one or more sourcework records corresponding to a final data record. The final data record pertains to a unique and distinct asset wherein the final data record is made up of one or more sourcework records. Each of the sourcework record is associated with a source identifier. In a preferred embodiment, the source identifiers are generated based on a hash of URL of data source from which sourcework records are retrieved. The final data record is indicative of the sourcework records and corresponding source identifiers. The sourcework data records can get updated based on new available data attributes or introduction of new data points or identification of new data sources for the asset.

Consequent to determination of change in sourcework records, the processor 102 is operable to receive a modifier sourcework record generated on account of either change in data quality of an existing sourcework record or availability of a new sourcework record pertaining to the asset. In an embodiment of the present embodiment, the modifier sourcework record consists of an existing sourcework record with new data attributes pertaining to the asset. Non-limiting examples of said case could be refinement of details related to auction of an asset such as last premium paid, or nationality of successful bidder etc. Optionally, the modifier sourcework record consists of information from a new data source pertaining to the asset. Non-limiting examples of said cases can be a new auction house releasing auction details of said asset which has higher number of data points as compared to previous data sources. In yet another embodiment, the modifier sourcework record contains information pertaining to removal of one or more sourceowrk records corresponding to the final data record. Example of such cases could be where it is determined that a final record made of 5 sourcework records, and the 5^{th} sourcework relates to a different asset and hence needs to be removed. The modifier sourcework record is associated with a modifier source identifier.

The processor 102 is further configured to retrieve, from a mapping repository, a final data record corresponding to the asset. The processor further retrieves a current final identifier associated with the final data record. The current final identifier is based on a combination of one or more source identifiers pertaining to the one or more sourcework records forming the final data record.

The mapping repository 106 comprises a mapping of each of the one or more source identifiers to the current final identifier. The mapping repository 106 further comprises a history of assignment of source identifier to the current final identifier along with a timestamp. The timestamp and history of assignment helps in assessing the trail of modifications to current final identifier.

The processor 102 is further operable to assign a new identifier for the asset by mapping the current final identifier to the modifier sourcework record based on a voting algorithm. In an embodiment of the present invention, the voting algorithm assigns the new identifier based on majority of common source identifiers in the modifier sourcework record. As an example, if 4 out of 5 sourcework records remain same and only 1 sourcework record changes, the current final identifier remains the same based on majority sourcework records remaining the same. In other embodiments, the processor is operable to generate a new identifier based on majority of modifier sourcework records in the final data record.

In another aspect of the present invention, the processor is configured to update the mapping repository with the new identifier for the final data record corresponding to the asset. In an embodiment, the current final identifier for the final data record is replaced by the new identifier during the updation by the processor. These are typically cases where the majority of sourcework records gets modified and hence a new identifier is generated. The old final identifier is also saved in the mapping repository along with the timestamp. Optionally, in cases where the current final identifier is maintained owing to voting algorithm, updation by the processor comprises preserving the current final identifier against the final data record in the mapping repository.

The method disclosed herein ensures there is a single unique identifier pertaining to a distinct asset at all times.

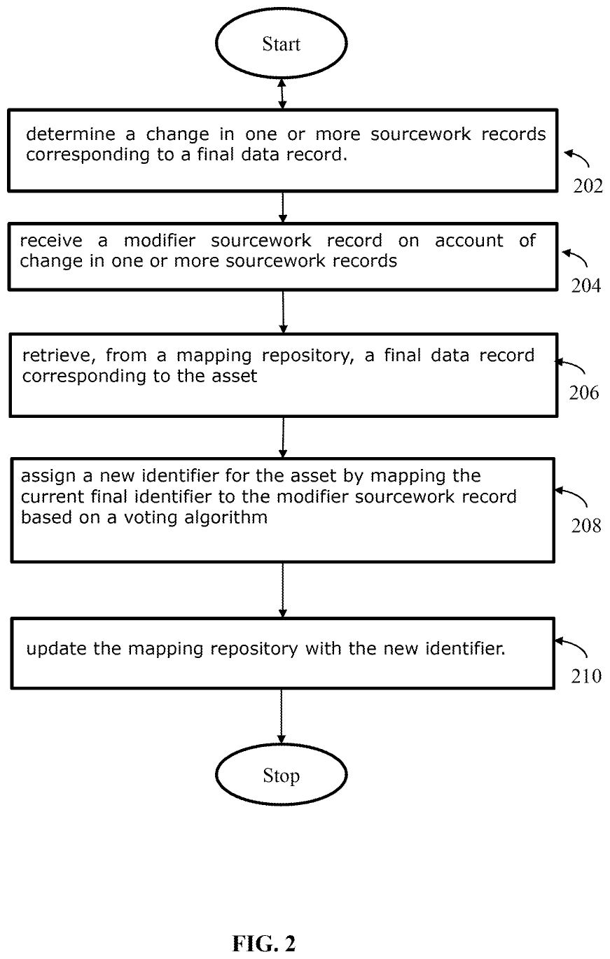

FIG. 2 is a flowchart 200 depicting the method steps of the invention disclosed herein. At step 202, the processor determines a change in one or more sourcework records corresponding to a final data record. At step 204, the processor receives a modifier sourcework record on account of change in one or more sourcework records. At step 206, the processor retrieves, from a mapping repository, a final data record corresponding to the asset. At step 208, the processor assigns a new identifier for the asset by mapping the current final identifier to the modifier sourcework record based on a voting algorithm. Finally at step 210, the processor updates the mapping repository with the new identifier.

The data communication network may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of the foregoing.

Any of the computer systems mentioned herein may utilize any suitable number of subsystems. In some embodiments, a computer system includes a single computer apparatus, where the subsystems can be components of the computer apparatus. In other embodiments, a computer system can include multiple computer apparatuses, each being a subsystem, with internal components.

A computer system can include a plurality of the components or subsystems, e.g., connected together by external interface or by an internal interface.

In some embodiments, computer systems, subsystems, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g., an application specific integrated circuit or field programmable gate array) and/or using computer software with a generally programmable processor 102 in a modular or integrated manner. As used herein a processor 102 includes a single-core processor, multi-core processor 102 on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor 102 using any suitable computer language such as, for example, Java, C, C++, C #, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer or other suitable display for providing any of the results mentioned herein to a user.

Any of the methods described herein may be totally or partially performed with a computer system including one or more processors, which can be configured to perform the steps. Thus, embodiments can be involve computer systems configured to perform the steps of any of the methods described herein, potentially with different components performing a respective steps or a respective group of steps. Although presented as numbered steps, steps of methods herein can be performed at a same time or in a different order. Additionally, portions of these steps may be used with portions of other steps from other methods. Also, all or portions of a step may be optional. Additionally, and of the steps of any of the methods can be performed with modules, circuits, or other means for performing these steps.

The specific details of particular embodiments may be combined in any suitable manner without departing from the spirit and scope of embodiments of the invention. However, other embodiments of the invention may be involve specific embodiments relating to each individual aspect, or specific combinations of these individual aspects. The above description of exemplary embodiments of the invention has been presented for the purpose of illustration and description. It is not intended to be exhaustive or to limit the invention to the precise form described, and many modifications and variations are possible in light of the teaching above. The embodiments were chosen and described in order to best explain the principles of the invention and its practical applications to thereby enable others skilled in the art to best utilize the invention in various embodiments and with various modifications as are suited to the particular use contemplated.

A recitation of “a”, “an” or “the” is intended to mean “one or more” unless specifically indicated to the contrary. The use of “or” is intended to mean an “inclusive or,” and not an “exclusive or” unless specifically indicated to the contrary.

1. A system for assigning a unique identifier for an asset, the system comprising a processor configured to execute non-transitory machine-readable instructions that when executed causes the processor to:
determines a change in one or more sourcework records corresponding to a final data record;
receives a modifier sourcework record on account of change in one or more sourcework records;
retrieves, from a mapping repository, a final data record corresponding to the asset wherein the final data record is associated with a current final identifier;
assign a new identifier for the asset by mapping the current final identifier to the modifier sourcework record based on a voting algorithm;
update the mapping repository with the new identifier for the asset.

2. The system of claim 1 wherein the mapping repository comprises a mapping of each of the one or more source identifiers to the current final identifier.

3. The system of claim 1 wherein the mapping repository further comprises a history of assignment of source identifier to the current final identifier along with a timestamp.

4. The system of claim 1 wherein the voting algorithm assigns the new identifier based on majority of common source identifiers.

5. The system of claim 1 wherein the final data record consists of one or more sourcework records and their corresponding source identifiers.

6. The system of claim 1 wherein the source identifiers are generated based on a hash of URL of data source from which sourcework records are retrieved.

7. The system of claim 1 wherein the modifier sourcework record consists of an existing sourcework record with new data attributes pertaining to the asset.

8. The system of claim 1 wherein the modifier sourcework record contains information pertaining to removal of one or more sourceowrk records corresponding to the final data record.

9. The system of claim 1 wherein updating the mapping repository comprises replacing the current final identifier by the new identifier.

10. The system of claim 1 wherein the updating the mapping repository comprises preserving the current final identifier based on the voting algorithm.

11. A method for assigning a unique identifier for an asset, the method comprising:
determining a change in one or more sourcework records corresponding to a final data record;
receiving a modifier sourcework record on account of change in one or more sourcework records;
retrieving, from a mapping repository, a final data record corresponding to the asset wherein the final data record is associated with a current final identifier;
assigning a new identifier for the asset by mapping the current final identifier to the modifier sourcework record based on a voting algorithm;
updating the mapping repository with the new identifier for the asset.

12. The method of claim 11 wherein the mapping repository comprises a mapping of each of the one or more source identifiers to the current final identifier.

13. The method of claim 11 wherein the mapping repository further comprises a history of assignment of source identifier to the current final identifier along with a timestamp.

14. The method of claim 11 wherein the voting algorithm assigns the new identifier based on majority of common source identifiers.

15. The method of claim 11 wherein the final data record consists of one or more sourcework records and their corresponding source identifiers.

16. The method of claim 11 wherein the source identifiers are generated based on a hash of URL of data source from which sourcework records are retrieved.

17. The method of claim 11 wherein the modifier sourcework record consists of an existing sourcework record with new data attributes pertaining to the asset.

18. The method of claim 11 wherein the modifier sourcework record contains information pertaining to removal of one or more sourceowrk records corresponding to the final data record.

19. The method of claim 11 wherein updating the mapping repository comprises replacing the current final identifier by the new identifier.

20. The method of claim 11 wherein the updating the mapping repository comprises preserving the current final identifier based on the voting algorithm.
